(19) United States
(12) Patent Application Publication
(10) Pub. No.: US 2002/0082333 A1
(43) Pub. Date: Jun. 27, 2002

(54) Silica gel-containing rubber compounds with organosilicon compounds as compounding agent

(76) Inventors: Rudiger Herpich, Mannheim (DE); Thomas Fruh, Ludwigshafen (DE); Ludger Heiliger, Neustadt (DE); Kurt Schilling, Schwetzingen (DE)

Correspondence Address: BAYER CORPORATION, PATENT DEPARTMENT, 100 BAYER ROAD, PITTSBURGH, PA, 15205, US

(21) Appl. No.: 09/951,034

(22) Filed: Sep. 10, 2001

(30) Foreign Application Priority Data
Sep. 13, 2000 (DE) 10045167.5

(51) Int. Cl. C08K 3/34; C08K 11/00

(52) U.S. Cl. 524/492; 524/442

(57) ABSTRACT

The invention concerns the use of organic silicon compounds in silica-containing rubber compounds, the process for their production and the process for compounding the silicon compounds with the rubbers and silica-containing fillers and vulcanizates manufactured from them.

An improvement in mechanical and dynamic properties is achieved by adding organic silicon compounds to silica-containing rubber compounds.

### FIELD OF THE INVENTION

The invention concerns the use of organic silicon compounds in silica-containing rubber compounds, the process for their production and the process for compounding the silicon compounds with the rubbers and silica-containing fillers and vulcanizates manufactured from them.

An improvement in mechanical and dynamic properties is achieved by adding organic silicon compounds to silica-containing rubber compounds.

### BACKGROUND OF THE INVENTION

The production and use of alkoxysilane-containing compounds in rubber compounds to improve the mechanical and dynamic properties of the vulcanizates is known and described in numerous patents.

For example, the use of 3,3-bis(triethoxysilylpropyl)tetrasulfide in silica-containing rubber compounds improves the wet-slip resistance while at the same time reducing rolling resistance in comparison to carbon black-filled tire tread compounds. During the vulcanization process, the use of SiO₂-containing fillers in conjunction with 3,3-bis(triethoxysilylpropyl)tetrasulfide leads to the formation of covalent rubber-filler bonds that provide an abrasion resistance comparable with that of tire tread carbon blacks (U. Görl, Gummi, Fasern, Kunststoffe, 1998, 51, 416-421).

3,3-bis(triethoxysilylpropyl)tetrasulfide is a typical representative of this class of compound. Although important rubber properties such as the above-mentioned dynamic properties are improved by the use of 3,3-bis(triethoxysilylpropyl)tetrasulfide, this improvement is achieved at the cost of substantially more complex compounding and processing in comparison to rubber compounds filled with carbon black. (H.-D. Luginsland “Processing of the Organo Silane Si 69” The International Rubber Chemicals and Compounding Conference, 22nd-23rd November 1999, Antwerp, Belgium).

For instance, silica-filled tire tread compounds containing 3,3-bis(triethoxysilylpropyl)tetrasulfide corresponding to the prior art are extremely susceptible to scorching and must under no circumstances exceed the temperature limit of 160° C. during compounding in an internal mixer.

This means that silica-filled tire tread compounds are compounded, cooled and stored up to four times before the unvulcanized mixes can be accelerated and converted, whereas in the case of carbon black-filled tire tread compounds, the unvulcanized mixes can be converted after being compounded only twice at higher compounding temperatures. Silica-filled tire compounds thus lead to an enormous fall in productivity in the tire manufacturer's entire production process.

### SUMMARY OF THE INVENTION

It is, therefore, desirable to produce a compound that allows the improved properties of the silica-filled compounds to be obtained. Yet, at the same time, compounding temperatures above 155° C. during processing is permitted and hence, allows fewer compounding stages than previously, thereby increasing the productivity of the tire manufacturing process.

### DETAILED DESCRIPTION OF THE INVENTION

The invention therefore provides rubber compounds containing

a) at least one oligomeric polydiene that by reason of a modification reaction exhibits thio-urethane groups and/or urea groups, or amide groups, each having silane substituents according to formula (I),

R¹R²R³Si—X—QH—Y—Z— (I)

wherein in formula (I)

| | |
|---|---|
| R¹, R², R³ | are the same or different and denote C₁-C₁₈ alkyl, |
| | preferably C₁-C₅ alkyl, C₁-C₁₈ alkoxy, preferably C₁-C₅ |
| | alkoxy, C₆-C₁₂ phenyl or phenoxy, preferably C₆ |
| | phenyl or phenoxy, C₇-C₁₈ alkylaryl or alkylaryloxy, |
| | with the proviso that at least one of the radicals R¹ to |
| | R³ is an alkoxy, phenoxy or alkylaryloxy group, |
| X | stands for linear, branched or cyclic, optionally |
| | unsaturated C₁-C₁₂ alkylene radicals, preferably |
| | linear, saturated C₁-C₆ alkylene radicals, and |
| Q | stands for S or NH |
| Y | stands for C═O or CH₂—CH—(OH)— |
| Z | stands for O, NH or X, |

b) at least one double bond-containing rubber and

c) at least one silicon-containing filler, and optionally additional rubber additives and other fillers.

The term oligomeric polydienes refers to all oligomeric dienes known to the person skilled in the art, particularly oligomeric polybutadienes, polyisoprenes, polychloroprenes, as well as oligomeric SBR and NBR rubbers.

The oligomeric polydienes that can be used, which by reason of a modification reaction exhibit (thio)urethane groups and/or urea groups, or amide groups, each having silane substituents according to formula (I), have molecular weights (Mn determined by GPC (using polystyrene standards as calibration substances)) of 500 to 5000, preferably 800 to 2000 g/mol.

In the context of the invention, double bond-containing rubbers are understood to be rubbers designated as R rubbers according to DIN/ISO 1629. These rubbers have a double bond in the main chain. They include, for example:

| | |
|---|---|
| NR: | natural rubber |
| SBR: | styrene-butadiene rubber |
| BR: | polybutadiene rubber |
| NBR: | nitrile rubber |
| IIR: | butyl rubber |
| HNBR: | hydrogenated nitrile rubber |
| SNBR: | styrene-butadiene-acrylonitrile rubber |
| CR: | polychloroprene |
| XSBR: | carboxylated styrene-butadiene rubber |
| XNBR: | carboxylated butadiene-acrylonitrile rubber |
| ENR: | epoxidized natural rubber |
| ESBR: | epoxidized styrene-butadiene rubber |

Alternatively, however, they can also be understood to be rubbers that are designated as M rubbers according to DIN/ISO 1629 and contain double bonds in side chains in addition to the saturated main chain. These include EPDM, for example.

NR, BR, SBR, IIR and EPDM are preferred.

Silicon-containing filler (C) refers to:

1. Fine-particle silica, produced e.g. by precipitating solutions of silicates or by flash hydrolysis of silicon halides with specific surface areas in the range from 5 to 1000, preferably 20 to 400 m²g⁻¹ (BET surface area) and primary particle sizes in the range from 5 to 400 nm. The silicas can optionally also be present as mixed oxides with other metal oxides, such as Al, Mg, Ca, Ba, Zn and Ti oxides;

2. Synthetic silicates, such as aluminum silicate, alkaline-earth silicate, such as magnesium silicate or calcium silicate with BET surface areas in the range from 20 to 400 m²g⁻¹ and primary particle diameters in the range from 5 to 400 nm;

3. Natural silicates, such as kaolin, zeolites and other naturally occurring silicas;

4. Glass fibers and glass fiber products (strips, strands or glass microbeads).

Fine-particle silicas and synthetic and natural silicates are preferred.

The content of a) is advantageously in the range from 1 to 20, preferably 5 to 10 parts by weight, the content of b) 100 parts by weight and the content of c) in the range from 50 to 90, preferably 70 to 90 parts by weight (phr).

The rubber compounds according to the present invention can also contain other components and fillers.

Particularly suitable additional components and fillers for production of the rubber compounds and vulcanizates according to the invention are:

1. Carbon blacks. The carbon blacks for use in this connection are produced according to the lamp black, furnace black or channel black method and have BET surface areas in the range from 20 to 200 m²g⁻¹, such as e.g. SAF, ISAF, IISAF, HAF, FEF or GPF carbon blacks;

2. Metal oxides, such as zinc oxide, calcium oxide, magnesium oxide, aluminum oxide;

3. Metal carbonates, such as calcium carbonate, magnesium carbonate, zinc carbonate;

4. Metal sulfates, such as calcium sulfate, barium sulfate;

5. Metal hydroxides, such as aluminum hydroxide and magnesium hydroxide;

6. Thermoplastic fibers (polyamide, polyester, aramide).

The specified fillers can be used alone or in combination. In a preferred embodiment of the process, 70 to 85 parts by weight of silicon-containing filler (c), optionally together with 5 to 10 parts by weight of carbon black, relative in each case to 100 parts by weight of uncrosslinked rubber (b), are used.

The rubber compounds according to the present invention can moreover also contain conventional rubber additives, such as crosslinking agents, reaction accelerators, antioxidants, heat stabilizers, light stabilizers, anti-ozonants, processing aids, plasticizers, tackifiers, blowing agents, dyestuffs, pigments, wax, extenders, organic acids, retarders, metal oxides, and filler activators such as triethanol amine, polyethylene glycol, hexane triol or others known in the rubber industry.

The rubber additives are used in conventional quantities, which are governed inter alia by the intended application. Conventional quantities are generally quantities in the range from 0.1 to 50 wt. %, relative to the quantities of rubber (B) used.

Sulfur, sulfur donors, peroxides or crosslinking agents, such as e.g. diisopropenyl benzene, divinyl benzene, divinyl ether, divinyl sulfone, diallyl phthalate, triallyl cyanurate, 1,2-polybutadiene, N,N′-m-phenylene maleimide and/or triallyl trimellitate, can be used as conventional crosslinking agents. Other possibilities include the acrylates and methacrylates of polyhydric, preferably dihydric to tetrahydric C₂ to C₁₀. alcohols, such as ethylene glycol, propanediol, 1,2-butanediol, hexanediol, polyethylene glycol with 2 to 20, preferably 2 to 8, oxyethylene units, neopentyl glycol, bisphenol A, glycerol, trimethylol propane, pentaerythritol, sorbitol with unsaturated polyesters of aliphatic diols and polyols together with maleic acid, fumaric acid and/or itaconic acid.

The rubber compounds according to the present invention can also contain vulcanization accelerators. Examples of suitable vulcanization accelerators are mercaptobenzothiazols, mercaptosulfenamides, guanidines, thiurams, dithiocarbamates, thio ureas and thiocarbonates together with dithiophosphates. The vulcanization accelerators, sulfur and sulfur donors or peroxides or other crosslinking agents, such as e.g. dimeric 2,4-toluylene diisocyanate or 1,4-bis-1-ethoxyhydroquinone, are used in quantities ranging from 0.1 to 40 wt. %, preferably 0.1 to 10 wt. %, relative to the total quantity of rubber used. Vulcanization of the rubber compounds according to the invention can be performed at temperatures in the range from 100 to 250° C., preferably 130 to 180° C., optionally under pressure of 10 to 200 bar.

The invention also provides a process for synthesizing oligomeric polydienes that by reason of a modification reaction display (thio)urethane groups and/or urea groups, or amide groups, each having silane substituents according to formula (I), characterized in that hydroxyl-terminated or isocyanate-terminated or anhydride-modified or epoxy-modified polydienes are reacted with silicon compounds according to formula (II)

R¹R²R³Si—X—Q (II)

wherein

Q denotes N=C=O, NH₂, SH

The molar ratio of polymer component to monomer component is advantageously in the range from 1.5:1 to 0.5:1, preferably 1.1:1 to 0.9:1, relative in each case to the functional groups. The reaction is advantageously performed without solvents, at temperatures in the range from 20 to 150° C., preferably 40 to 120° C., optionally using a tin-containing catalyst in a concentration in the range from 0.1 to 2%, preferably 0.1 to 1%, relative to the total reaction batch.

The reaction is continued until an NCO content of >0.1% can be determined.

The present invention also provides a process for synthesizing oligomeric polydienes that by reason of a modification reaction display (thio)urethane groups and/or urea groups, or amide groups, each having silane substituents according to formula (I), characterized in that corresponding hydroxyl-terminated polymer component is reacted with a diisocyanate.

To this end, a molar ratio of polymer component to diisocyanate is selected in the range from 1.5:1 to 0.5:1, preferably 1.1:1 to 0.9:1. The reaction is advantageously performed without catalyst at a temperature in the range from 20 to 90° C., preferably 40 to 80° C.

As soon as the reaction mixture exhibits an NCO content displaying half of the unreacted mixture, a silicon compound according to formula (II), in which Q denotes NH₂ or SH, is advantageously added, and for the isocyanate-thiol addition the use of a tin-containing catalyst in a concentration in the range from 0.1 to 2%, preferably 0.1 to 1%, relative to the total reaction batch, is optionally advantageous. The temperature is advantageously in the range from 20 to 90° C., preferably 40 to 80° C. The reaction is generally continued until an NCO content of >0.1% can be determined.

The present invention also provides a compounding process for the rubber compounds according to the present invention, characterized in that the rubber compounds according to the present invention are mixed in a mixing device, preferably an internal mixer or compounding extruder, at temperatures above 155° C., preferably in the range from 155 to 200° C., particularly preferably in the range from 160° C. to 180° C.

The addition of other compound components to the rubber compound according to the present invention can be performed in the same processing stage as the compounding process according to the present invention or in a subsequent processing stage in conventional equipment such as e.g. rolls, calendars or extruders. Preferred compounding temperatures are in the range from 50 to 180° C.

Corresponding vulcanizates can be produced from the rubber compounds according to the present invention by means of vulcanization, these vulcanizates being suitable for the production of shaped articles, e.g. for the production of cable sheaths, hoses, drive belts, conveyor belts, roll coverings, tires, especially tire treads, shoe soles, sealing rings and damping elements, as well as membranes, particularly preferably for the production of tire treads.

### EXAMPLES

1. Production of Alkoxysilane-containing Polybutadienes.

1.1 20.0 g Krasol® LBD 3000 (isocyanate-terminated polybutadiene from Kaucuk a.s., molecular weight: approx. 3000 g/mol, NCO content: 2.8%) are heated to 120° C. and 3.0 g triethoxysilyl-n-propylamine (Dynasylan® AMEO, Sivento GmbH) are added. After 15 minutes the NCO content is 0.0%.

1.2 0.7 g tin di(2-ethyl)hexanoate (Desmorapid® SO from Rhein Chemie Rheinau GmbH) and 25.0 g 3-isocyanato-n-propyl triethoxysilane (Fluka) are added to 105.1 g Krasol® LBD 2000 (hydroxyl-terminated polybutadiene from Kaucuk a.s., molecular weight approx. 2000 g/mol, hydroxyl value: 48 mg KOH/g) at room temperature. After 2 hours the NCO content is 0.0%.

1.3 2.9 g tin di(2-ethyl)hexanoate (Desmorapide SO from Rhein Chemie Rheinau GmbH) and 200 g 3-isocyanato-n-propyl triethoxysilane (Fluka) are added to 378.4 g PolyBd® R 20 LM (hydroxyl-terminated polybutadiene from Elf Atochem, molecular weight 1200 g/mol, hydroxyl value: 109 mg KOH/g) at room temperature. After 1 day the NCO content is 0.0%.

1.4 23.3 g isophorone diisocyanate (NCO content: 39.7% from Degussa-Huls) are added to 105 g PolyBd® R 20 LM (hydroxyl-terminated polybutadiene from Elf Atochem, molecular weight 1200 g/mol, hydroxyl value: 107 mg KOH/g). After stirring for 3 hours at 50° C., 24.4 g triethoxysilyl-n-propylamine (Dynasylan® AMEO, Sivento GmbH) are added. After a further 1.5 hours the NCO content is 0.0%.

2. Compounding Process

Compounds 2.1-2.2:

1st compounding stage:

I. Intermeshing mixer (Francis Shaw & Co. Ltd.)

II. Fill level 63.3 vol. %

III. Compounding procedure:

Cooling temperature adjusted to 110° C.

Mastication at 30 rpm for 60 s

Dispersion of ½ of the silica and the 3,3-bis(triethoxysilylpropyl)tetrasulfide or product 1.2 from example 1 at 40 rpm for 30 s, dispersion of the 2^{nd} half of the silica, carbon black, oil and other additives at 40 rpm for 20 s

Post-compounding at 20 rpm for 110 s.

2^{nd} and 3^{rd} compounding stage:

IV. Intermeshing mixer (Francis Shaw & Co. Ltd.)

V. Fill level 63.3 vol. %

VI. Compounding procedure:

Cooling temperature adjusted to 110° C.

Compounding at 40 rpm until ejection temperature of 145° C. is reached.

For compounds 2.3 to 2.8, the above compounding procedure applies, except that the ejection temperature for the 2^{nd} and 3^{rd} stage in step III. and VI is 165° C.

3. Rubber Tests

TABLE 1

| Formulation 1 | Compd 1 | Compd 2 | Compd 3 | Compd 4 | Compd 5 | Compd 6 | Compd 7 | Compd 8 |
|---|---|---|---|---|---|---|---|---|
| Compound component | phr | phr | phr | phr | phr | Phr | phr | phr |
| Buna CB 24 | 30 | 30 | 30 | 30 | 30 | 30 | 30 | 30 |
| Buna VSL 5025-1 | 96 | 96 | 96 | 96 | 96 | 96 | 96 | 96 |
| Vulkasil S | 80 | 80 | 80 | 80 | 80 | 80 | 80 | 80 |
| ZnO active | 3 | 3 | 3 | 3 | 3 | 3 | 3 | 3 |
| Stearic acid | 2 | 2 | 2 | 2 | 2 | 2 | 2 | 2 |
| Vulkanox 4010 NA | 1.5 | 1.5 | 1.5 | 1.5 | 1.5 | 1.5 | 1.5 | 1.5 |
| Vulkanox HS | 1 | 1 | 1 | 1 | 1 | 1 | 1 | 1 |
| Aktiplast ST | 4 | 4 | 4 | 4 | 4 | 4 | 4 | 4 |
| Naftolen ZD | 10 | 10 | 10 | 10 | 10 | 10 | 10 | 10 |
| Antilux 654 | 1 | 1 | 1 | 1 | 1 | 1 | 1 | 1 |
| 3,3-bis(triethoxysilylpropyl)- | 6.4 | — | — | — | — | — | — | — |
| tetrasulfide | | | | | | | | |
| Product no. 1.2 | — | 6.4 | 6.4 | 6.4 | 6.4 | 12.8 | 6.4 | 12.8 |
| Sulfur | 1.7 | 1.7 | 1.7 | 1.7 | 1.7 | 1.7 | 1.7 | 1.7 |
| Vulkacit D | 2 | 2 | 2 | 2 | 2 | 2 | 2 | 2 |
| Vulkacit CZ | 1.7 | 1.7 | 1.7 | 1.7 | 1.7 | 1.7 | 1.7 | 1.7 |
| Rhenocure IS-90/G | — | — | — | 2 | — | — | — | — |
| Rhenocure SDT/S | — | — | — | — | 2 | 2 | 2 | 2 |
| Addition of silane | 5.94 × 10⁻² | 1.88 × 10⁻² | 1.88 × 10⁻² | 1.88 × 10⁻² | 1.88 × 10⁻² | 3.77 × 10⁻² | 1.88 × 10⁻² | 3.77 × 10⁻² |
| derivatives [mol] | | | | | | | | |
| All alternative systems | | | | | | | | |
| are added in significantly | | | | | | | | |
| lower molar quantities | | | | | | | | |
| than the 3,3-bis- | | | | | | | | |
| (triethoxysilylpropyl)- | | | | | | | | |
| tetrasulfide | | | | | | | | |
| Ejection temperature | 145 | 145 | 165 | 165 | 165 | 165 | 165 | 165 |
| Number of mixing stages | 3 | 3 | 3 | 3 | 3 | 3 | 2 | 2 |
| 3,3-bis(triethoxysilylpropyl)- | 539 | | | | | | | |
| tetrasulfide [g/mol] | | | | | | | | |
| Product no. 1.2 [g/mol] | 1700 | Product | | | | | | |
| | | no.1; | | | | | | |
| Compound testing | | | | | | | | |
| Mooney viscosity ML 1 + 4, | 54 | 55 | 53 | 54 | 53 | 51 | 52 | 50 |
| 100° C., DIN 53523, [ME] | | | | | | | | |
| Mooney scorch, 120° C., | 27.2 | 28.1 | 27.6 | 25.1 | 23.9 | 23.3 | 23.1 | 23 |
| DIN 53523 t5 [min] | | | | | | | | |
| t35 [min] | 36.8 | 36.2 | 35.8 | 29.8 | 28.1 | 27.6 | 27.9 | 27.7 |
| Rheometer test, 160° C., | 4.5 | 4.6 | 4.2 | 3.9 | 3.4 | 3.4 | 3.2 | 3.3 |
| DIN 53529 t10% [min] | | | | | | | | |
| t90% [min] | 10.2 | 9.7 | 9.7 | 9.1 | 8.7 | 8.6 | 8.1 | 8.5 |
| t95% [min] | 12.1 | 10.5 | 10.1 | 9.4 | 8.9 | 8.8 | 8.7 | 9 |
| Torque differential [Nm] | 38.6 | 35.3 | 34.9 | 38.9 | 38.4 | 37.9 | 38.9 | 38.7 |
| Vulcanization test after 160° C./ | | | | | | | | |
| t95% | | | | | | | | |
| Impact resilience, 23° C., | 35 | 36 | 36 | 37 | 36 | 38 | 37 | 39 |
| DIN 53512, [%] | | | | | | | | |
| Impact resilience, 70° C., | 53 | 51 | 54 | 55 | 54 | 56 | 55 | 57 |
| DIN 53512, [%] | | | | | | | | |
| Shore-A hardness, 23° C., | 68 | 64 | 65 | 66 | 65 | 67 | 66 | 67 |
| DIN 53505 | | | | | | | | |
| 25% modulus, 23° C., DIN 53504, | 1.15 | 1.21 | 1.19 | 1.23 | 1.25 | 1.22 | 1.24 | 1.26 |
| [MPa] | | | | | | | | |
| 100% modulus, 23° C., | 3.1 | 2.3 | 2.1 | 2.4 | 2.6 | 2.8 | 2.7 | 2.9 |
| DIN 53504, [MPa] | | | | | | | | |
| 300% modulus, 23° C., | 12 | 9.9 | 9.5 | 9.6 | 9.9 | 10.5 | 10.4 | 10.9 |
| DIN 53504, [MPa] | | | | | | | | |
| Tensile strength, 23° C., | 17.9 | 16.1 | 15.4 | 16.2 | 16.5 | 16.9 | 17.2 | 17.5 |
| DIN 53504, [MPa] | | | | | | | | |
| Elongation at break, 23° C., | 451 | 528 | 515 | 495 | 479 | 448 | 457 | 473 |
| DIN 53504, [%] | | | | | | | | |
| 300 modulus/100 modulus | 3.9 | 4.3 | 4.5 | 4.0 | 3.8 | 3.8 | 3.9 | 3.8 |
| Compression set, 1 day, 70° C., | 24 | 20 | 21 | 23 | 19 | 20 | 19 | 19 |
| [%] | | | | | | | | |
| Abrasion, 23° C., DIN 53516, | 96 | 103 | 106 | 98 | 92 | 93 | 98 | 104 |
| [mm³] | | | | | | | | |
| Viscoelastic properties, DIN 53513 | 0.41 | 0.423 | 0.433 | 0.409 | 0.44 | 0.448 | 0.451 | 0.458 |
| tan d, 0° C. | | | | | | | | |
| tan d, 70° C. | 0.135 | 0.141 | 0.139 | 0.141 | 0.128 | 0.125 | 0.118 | 0.117 |

Buna ® CB 24: Bayer AG, polybutadiene, Mooney viscosity 38-48 (1 + 4, 100° C.)
Buna ® VSL 5025-1: Bayer AG, SBR rubber (Mooney viscosity 50 (ML 1 + 4, 100° C.)
Vulkasil ® S: Bayer AG, active silica
ZnO active: Bayer AG
Vulkanox ® 4010 NA: Bayer AG, N-isopropyl-N′-phenyl-p-phenylene diamine
Vulkanox ® HS: Bayer AG, oligomerized 2,2,4-trimethyl-1,2-dihydroquinoline
Aktiplast ® ST: Rhein Chemie Rheinau GmbH, mixture of hydrocarbons, zinc soaps and fillers
Naftolen ZD: Chemetall GmbH, aromatic lubricating plasticizer
Antilux ® 654: Rhein Chemie Rheinau GmbH, light stabilizing wax
Vulkacit ® D: Bayer AG, diphenyl guanidine
Vulkacit ® CZ: Bayer AG, N-cyclohexyl-2-benzothiazylsulfenamide
Rhenocure ® IS-90/G: Rhein Chemie Rheinau GmbH, insoluble sulfur
Rhenocure ® SDT: Rhein Chemie Rheinau GmbH, sulfur donor

It is clear from the above rubber tests that the good mechanical and dynamic properties can be retained with the rubber compounds and compounding process according to the invention. Increasing the ejection temperature to 165° C. eliminates one of the compounding steps, thereby enormously improving the productivity of the process.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber compounds comprising
a) at least one oligomeric polydiene comprising (thio)urethane groups and/or urea groups, or amide groups, each having silane substituents according to formula (I),
R¹R²R³Si—X—QH—Y—Z— (I)
wherein in formula (I)
R¹, R², R³ are the same or different and denote a C₁-Cl₁₈ alkyl, wherein at least one of the radicals R¹ to R³ is an alkoxy, phenoxy or alkylaryloxy group,
X stands for linear, branched or cyclic, optionally unsaturated C₁-C₁₂ alkylene radicals, and
Q stands for S or NH and
Y stands for C=O or CH₂—CH—(OH)—
Z stands for O, NH or X,
b) at least one double bond-containing rubber and
c) at least one silicon-containing filler, and optionally additional rubber additives and other fillers.

2. A rubber compound according to claim 1, wherein R¹, R², R³ denotes a C₁-C₅ alkyl or C₁-C₁₈ alkoxy.

3. A rubber compound according to claim 2, wherein said C₁-C₁₈ alkoxy is C₁-C₅ alkoxy, C₆-C₁₂ phenyl or phenoxy.

4. A rubber compound according to claim 3, wherein said C₁-C₁₈ alkoxy is C₆ phenyl or phenoxy, C₇-C₁₈ alkylaryl or alkylaryloxy

5. A rubber compound according to claim 1, wherein X is linear, saturated C₁-C₆alkylene radicals.

6. Rubber compounds according to claim 1, wherein the content of said component (a) is in the range from 1 to 20 parts by weight, the content of said component (b) is 100 parts by weight and the content of said component (c) is in the range from 50 to 90 parts by weight.

7. Rubber compounds according to claim 1, wherein said rubber (b) is selected from the group consisting of NR, BR, SBR and IIR or mixtures of two or more members of the group.

8. Rubber compounds according to claim 1, wherein said filler (c) is selected from the group consisting of silicas, silicon dioxide, silica gels and natural or synthetic silicates or mixtures of two or more members of the group.

9. A compounding process for rubber compounds comprising the step of compounding rubber compounds in a mixing device at temperatures above 155° C., wherein said rubber compound comprises
a) at least one oligomeric polydiene comprising (thio)urethane groups and/or urea groups, or amide groups, each having silane substituents according to formula (I),
R¹R²R³Si—X—QH—Y—Z— (I)
wherein in formula (I)

| | |
|---|---|
| R¹, R², R³ | are the same or different and denote a C₁-C₁₈ |
| | alkyl, wherein at least one of the radicals R¹ to |
| | R³ is an alkoxy, phenoxy or alkylaryloxy group, |
| X | stands for linear, branched or cyclic, optionally |
| | unsaturated C₁-C₁₂ alkylene radicals, and |
| Q | stands for S or NH and |
| Y | stands for C═O or CH₂—CH—(OH)— |
| Z | stands for O, NH or X, |

b) at least one double bond-containing rubber and
c) at least one silicon-containing filler, and optionally additional rubber additives and other fillers.

10. A compounding process according to claim 9, wherein said mixing device is an internal mixer or compounding extruder.

11. A molded article comprising a rubber compound which comprises
a) at least one oligomeric polydiene comprising (thio)urethane groups and/or urea groups, or amide groups, each having silane substituents according to formula (I),
R¹R²R³Si—X—QH—Y—Z— (I)
wherein in formula (I)

| | |
|---|---|
| R¹, R², R³ | are the same or different and denote a C₁-C₁₈ |
| | alkyl, wherein at least one of the radicals R¹ to |
| | R³ is an alkoxy, phenoxy or alkylaryloxy group, |
| X | stands for linear, branched or cyclic, optionally |
| | unsaturated C₁-C₁₂ alkylene radicals, and |
| Q | stands for S or NH and |
| Y | stands for C═O or CH₂—CH—(OH)— |
| Z | stands for O, NH or X, |

b) at least one double bond-containing rubber and
c) at least one silicon-containing filler, and optionally additional rubber additives and other fillers.
Although the invention has been described in detail in the foregoing for the purpose of illustration, it is to be understood that such detail is solely for that purpose and that variations can be made therein by those skilled in the art without departing from the spirit and scope of the invention except as it may be limited by the claims.
